(19) United States
(12) Patent Application Publication
(10) Pub. No.: US 2010/0009658 A1
(43) Pub. Date: Jan. 14, 2010

(54) METHOD FOR IDENTITY AUTHENTICATION BY MOBILE TERMINAL

(75) Inventors: YI-FANG WU, Tu-Cheng (TW); DAN-FENG WU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/241,602

(22) Filed: Sep. 30, 2008

(30) Foreign Application Priority Data
Jul. 8, 2008 (CN) 200810302658.2

(51) Int. Cl. H04W 12/06

(52) U.S. Cl. 455/411

(57) ABSTRACT

A method for identity authentication includes: providing a mobile terminal, displaying a plurality of input areas on the mobile terminal, inputting a password to the mobile terminal by tapping the input areas in a proper sequence with fingers of a user, and identifying fingerprints of the fingers on the input areas while inputting the password.

### BACKGROUND

1. Technical Field

The present invention relates to methods for identity authentication and, more particularly, to a secure method of identity authentication by a mobile terminal.

2. Description of Related Art

Mobile terminals, such as mobile phones, are typically provided with a password registration function for registering a password to protect against unauthorized use. Once an authorized user has registered a password, the phone cannot be operated without entering the registered password.

However, because users usually input passwords using a keypad of the mobile terminal, there is a risk that someone may observe the operation and obtain the password.

What is needed, therefore, is a secure method for identity authentication by a mobile terminal.

### BRIEF DESCRIPTION OF THE DRAWINGS

FIG. 1 is a schematic diagram of a mobile phone using an embodiment of a method for identity authentication by a mobile terminal; and

FIG. 2 is a flow chart of the embodiment of the method for identity authentication by a mobile terminal.

### DETAILED DESCRIPTION OF THE EMBODIMENTS

Many aspects of the embodiments can be better understood with reference to the drawings. The components in the drawings are not necessarily drawn to scale, the emphasis instead being placed upon clearly illustrating the principles of the embodiments.

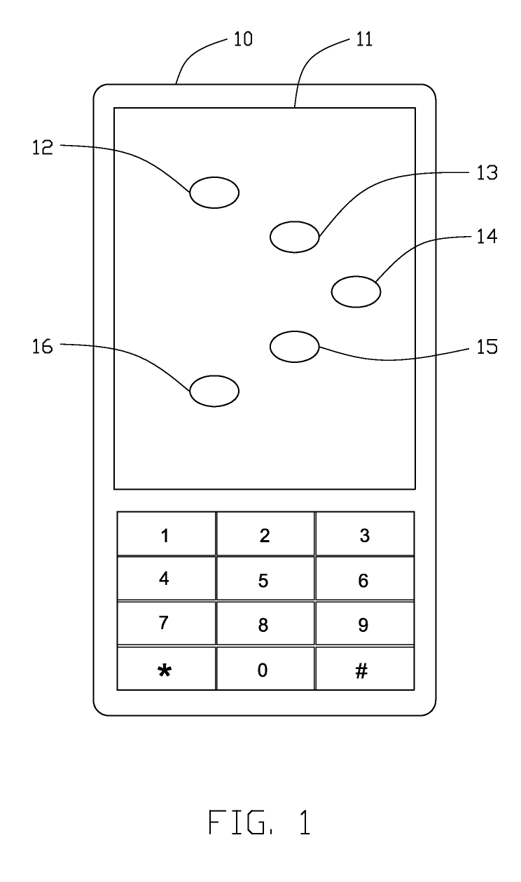

Referring to FIG. 1, a schematic diagram of a mobile phone 10 using an embodiment of a method for identity authentication by a mobile terminal is shown. The mobile phone 10 includes a touch sensitive screen 11 having five input areas 12, 13, 14, 15, 16 that are touch sensitive and capable of recording fingerprints. The input areas 12, 13, 14, 15, 16 are arranged so that a user may simultaneously touch five finger pads using one hand. An inductor is positioned under each input area for sensing the touch or tap of a finger pad. The mobile phone 10 also includes a control clip allowing a user to associate a character with each input area such as a letter or a number to form a user password, receiving an inductive signal from each inductor under each input area, and transforming each inductive signal to the associated character.

If the user password for identity authentication in the mobile phone 10 is, for example, 1122abc, and the five fingerprints of the user are correspondingly stored in the mobile phone 10 through the input areas 12, 13, 14, 15, 16, the control clip will associate each character of the user password with each input area. For example, the input area 12 will be associated with an input of the number 1, the input area 13 will be associated with an input of the number 2, the input area 14 will be associated with an input of the letter a, the input area 15 will be associated with an input of the letter b, the input area 16 will be associated with an input of the letter c. In one embodiment, the phone 10 can be programmed as follows. When the user is prompted to authenticate their identity, the input areas 12, 13, 14, 15, 16 will be displayed on the touch sensitive screen 11. At this time, the user puts their fingers on the corresponding input areas 12, 13, 14, 15, 16, to record their fingerprints, and then taps the input area 12 twice with a first finger, the input area 13 twice with a second finger, the input area 14 once with a third finger, the input area 15 once with a fourth finger, and the input area 16 once with the fifth finger. During tapping the password the other fingers should remain in position pressing against the input areas. When each input area is tapped, the corresponding inductor will generate an inductive signal to the control clip, and the control clip will transform the inductive signals to the associated characters, 1122abc, in this example. In other embodiments, the phone 10 can be programmed so that the user first simultaneously touches the input areas to enter their fingerprints, and then uses any finger to tap the appropriate input areas in proper sequence to enter their password. Alternatively, the phone 10 can be programmed so that the user taps the input areas in sequence but using the finger that corresponds to that area so that their fingerprint is captured at the same time that the associated character input is recorded. The mobile phone 10 will compare the transformed characters and the fingerprints of the input areas with an original password stored in the mobile phone 10 by the user. If the transformed characters and the fingerprints are the same as the original password, the mobile phone 10 passes the identity authentication, and then the user can use the mobile phone 10.

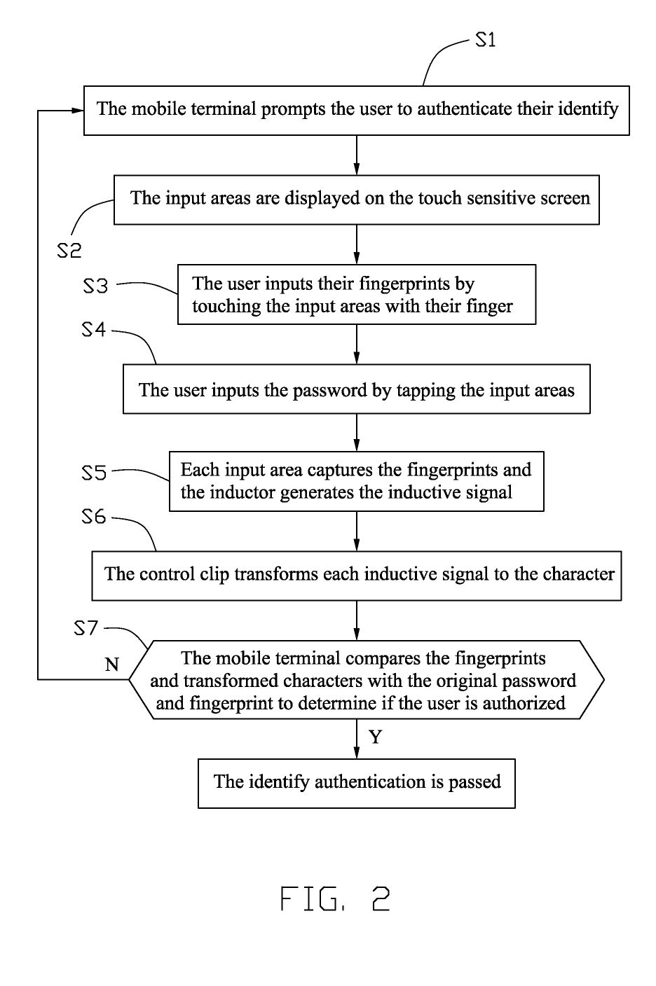

Referring to FIG. 2, is a flow chart of the method for identity authentication by the mobile terminal. Depending on the embodiment, certain of the steps described below may be removed, others may be added, and the sequence of steps may be altered.
S 1: The mobile terminal prompts the user to authenticate their identity;
S 2: Five input areas are displayed on a touch sensitive screen of the mobile terminal;
S 3: The user inputs their fingerprints by touching the input areas with their finger;
S 4: The user inputs the password to the mobile terminal by tapping the input areas in a proper sequence with the appropriate fingers;
S 5: Each input area captures the fingerprints when the fingers of the user are pressed against the input areas; the inductor under each input area tapped by the user generates an inductive signal to the control clip in the mobile terminal;
S 6: The control clip transforms each inductive signal to the associated character of the input area;
S 7: The mobile terminal compares the fingerprints and transformed characters with the original password and fingerprint set stored in the mobile terminal by the user, to determine if the user is authorized to use the mobile terminal; if the password and the fingerprints match, the identify authentication is passed and additional functions of the mobile terminal are activated and ready for use; if no match, the mobile terminal may, for example, prompt the user to try again, and if after a predetermined number of tries the mobile terminal may be programmed to shut down for a period of time or to automatically send an SMS message to another mobile terminal alerting the receiver that an unauthorized user is trying to access functions of the mobile terminal.

It is to be understood, however, that even though numerous characteristics and advantages of the embodiments have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for identity authentication, comprising:
providing a mobile terminal;
displaying a plurality of input areas on the mobile terminal;
inputting a password to the mobile terminal by tapping the input areas in a proper sequence with fingers of a user; and
identifying fingerprints of the fingers on the input areas while inputting the password.

2. The method of claim 1, wherein a number of the plurality of input areas displayed on the mobile terminal is equal to a number of different characters of the password, and the input areas are associated with the different characters of the password.

3. The method of claim 1, wherein an inductor is positioned under each corresponding input area for sensing the touch of a finger, and when each input area is touched, the each inductor generates an inductive signal when the corresponding input area is touched.

4. The method of claim 3, wherein the mobile terminal comprises a control clip configured to associate a character with each input area, receive the inductive signal from each inductor under each input area, and transform each inductive signal to the associated character.

5. The method of claim 4, further comprising passing the identity authentication, if the transformed characters and the fingerprint of each input area match an original password and a fingerprint set stored in the mobile terminal for identity authentication.

6. The method of claim 5, further comprising suggesting authenticating identity again and returning to displaying the plurality of input areas on the mobile terminal, if the transformed characters or the fingerprint of each input area does not match the original password and the fingerprint set stored in the mobile terminal.

7. The method of claim 1, wherein the plurality of input areas are arranged so that a user may simultaneously touch the input areas with five fingers.

8. The method of claim 1, wherein the input areas are displayed on a touch sensitive screen of the mobile terminal.

9. A method for identity authentication, comprising:
providing a mobile terminal;
displaying a plurality of input areas on the mobile terminal;
associating each input area with a different character of a password;
inputting the password to the mobile terminal by touching the input areas using fingers;
generating an inductive signal from each input area touched by the fingers;
transforming the inductive signal to the associated character of the password; and
comparing the transformed characters and the fingerprint of each finger on each input area with an original password and a fingerprint set stored in the mobile terminal for identity authentication; and
passing the identity authentication if matching.

10. The method of claim 9, further comprising suggest authenticating identity again if the transformed characters or the fingerprint of each input area does not match the original information stored in the mobile terminal.

11. The method of claim 9, wherein the plurality of input areas are arranged so that a user may simultaneously touch the input areas with five fingers.

12. The method of claim 9, wherein the input areas are displayed on a touch sensitive screen of the mobile terminal.
